(19) United States
(12) Patent Application Publication
(10) Pub. No.: US 2015/0163297 A1
(43) Pub. Date: Jun. 11, 2015

(54) LOAD CONTROL SYSTEM, LOAD CONTROL SERVER, INFORMATION PROCESSING SYSTEM, LOAD CONTROL METHOD AND RECORDING MEDIUM

(71) Applicant: NEC CORPORATION, Tokyo (JP)

(72) Inventor: Masaki Kan, Tokyo (JP)

(73) Assignee: NEC CORPORATION, Tokyo (JP)

(21) Appl. No.: 14/407,178

(22) PCT Filed: Jul. 9, 2013
(86) PCT No.: PCT/JP2013/068746

§ 371 Date: Dec. 11, 2014

(30) Foreign Application Priority Data
Aug. 6, 2012 (JP) 2012-173799

(51) Int. Cl. H04L 29/08

(52) U.S. Cl. CPC H04L 67/1008

(57) ABSTRACT

A load control system includes: receiving means that receives load information that indicates a magnitude of a load of a first processing device, which is one processing device from among processing devices that receive terminal relation information about a mobile terminal and that carry out a processing, which is assigned to the processing device itself, by using the terminal relation information; and in a specific situation in which the magnitude of the load is equal to or greater than a predetermined level or is approaching the predetermined level, control means that causes a second processing device, which is different from the first processing device from among the processing devices, to carry out a part of the processing that is assigned to the first processing device.

### TECHNICAL FIELD

The present invention relates to a load control system, a load control server, an information processing system, a load control method and a recording medium; and particularly relates to a load control system that controls a load of a processing device that communicates with mobile terminals, a load control server, an information processing system, a load control method and a recording medium.

### BACKGROUND ART

There has been known a system (hereinbelow referred to as “an information notice system”) that notifies a mobile terminal, such as a vehicle or a portable device, of information by using a wireless communication network (see Patent Document 1).

The information notice system identifies information which is used to support safety or advertisement information (hereinbelow referred to as “providing information” collectively) for each mobile terminal by using location information of the mobile terminal (for example, a vehicle), and notifies the mobile terminal of the providing information.

### CITATION LIST

### Patent Documents

Patent Document 1: JP2009-157503A

### SUMMARY OF INVENTION

### Problem to be Solved by the Invention

The amount of processing (hereinbelow referred to as “identified notice processing”), which identifies and gives notification of the providing information for each mobile terminal, increases in accordance with an increase of mobile terminals and in accordance with an increase of the providing information. Therefore, it is thought that a plurality of processors deal with a specific notice processing in distributed processing.

When a plurality of the processors deal with the specific notice processing in distributed processing, the load of each processor varies in accordance with the number of the mobile terminals that are handled by the processor or in accordance with the content of the processing that is handled by the processor (for example, the content of the processing to identify the providing information).

Therefore, the problem occurs that the processor, which has a lot of a load, in the processors, cannot carry out the specific notice processing appropriately.

An object of the present invention is to provide a load control system, a load control server, an information processing system, a load control method and a recording medium that can solve the foregoing problems.

### Means that Solve the Problem

A load control system according to the present invention includes:

receiving means that receives load information that indicates a magnitude of a load of a first processing device, which is one processing device from among processing devices that receive terminal relation information about a mobile terminal and that carry out an assigned processing by using the terminal relation information;

in a specific situation in which the magnitude of the load is equal to or greater than a predetermined level or is approaching the predetermined level, control means that causes a second processing device, which is different from the first processing device from among the processing devices, to carry out a part of a processing that is assigned to the first processing device.

A load control server according to the present invention includes:

receiving means that receives load information that indicates a magnitude of a load of a first processing device, which is one processing device from among processing devices that receive terminal relation information about a mobile terminal and that carry out an assigned processing by using the terminal relation information;

in a specific situation in which the magnitude of the load is equal to or greater than a predetermined level or is approaching the predetermined level, control means that cause a second processing device, which is different from the first processing device from among the processing devices, to carry out a part of a processing that is assigned to the first processing device.

A load control method according to the present invention includes:

receiving load information that indicates a magnitude of a load of a first processing device, which is one processing device from among processing devices that receive terminal relation information about a mobile terminal and that carry out an assigned processing by using the terminal relation information;

in a specific situation in which the magnitude of the load is equal to or greater than a predetermined level or is approaching the predetermined level, causing a second processing device, which is different from the first processing device from among the processing devices, to carry out a part of a processing that is assigned to the first processing device.

A recording medium according to the present invention is a computer readable record medium that records a program causing a computer to execute procedures including:

receiving load information that indicates a magnitude of a load of a first processing device, which is one processing device from among processing devices that receive terminal relation information about a mobile terminal and that carry out an assigned processing by using the terminal relation information;

in a specific situation in which the magnitude of the load is equal to or greater than a predetermined level or is approaching the predetermined level, causing a second processing device, which is different from the first processing device from among the processing devices, to carry out a part of a processing that is assigned to the first processing device.

### Effect of the Invention

According to the present invention, it is possible to inhibit the concentration of the load in any one of processors.

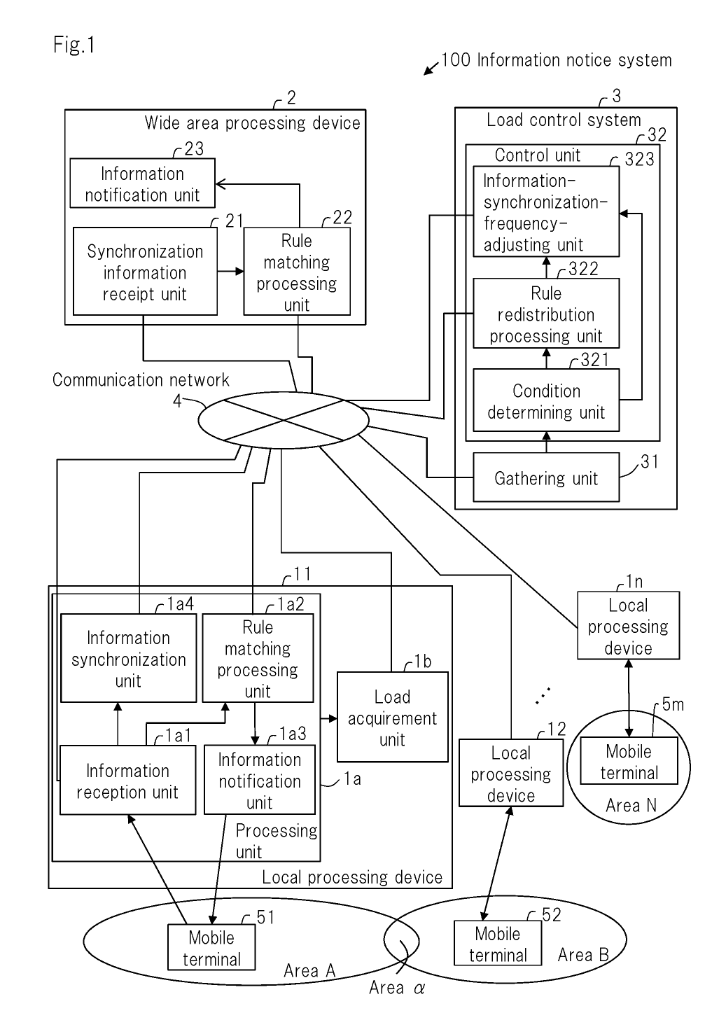

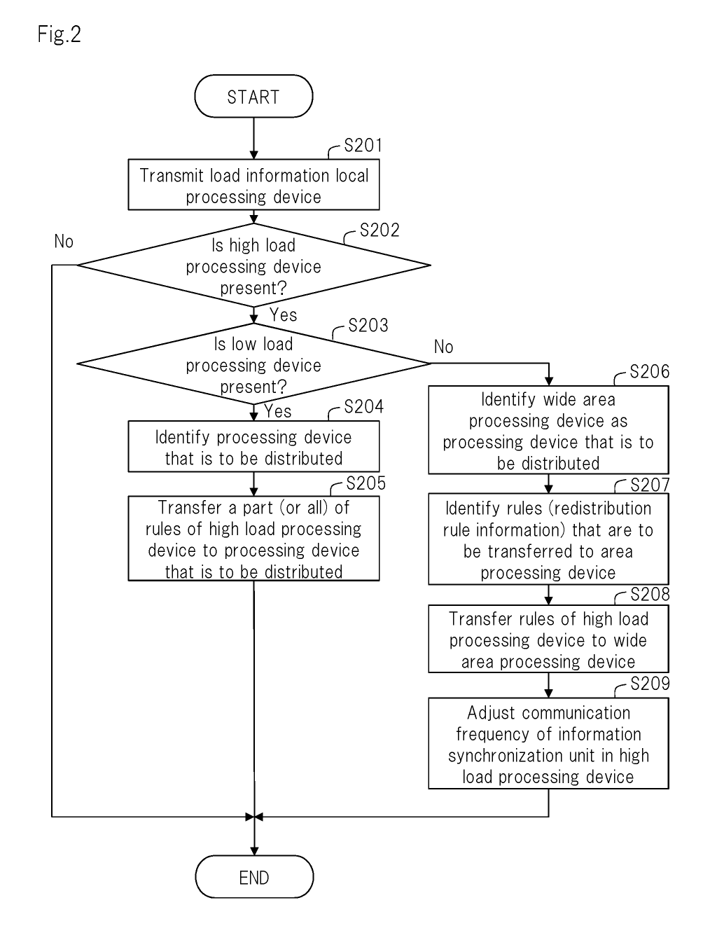

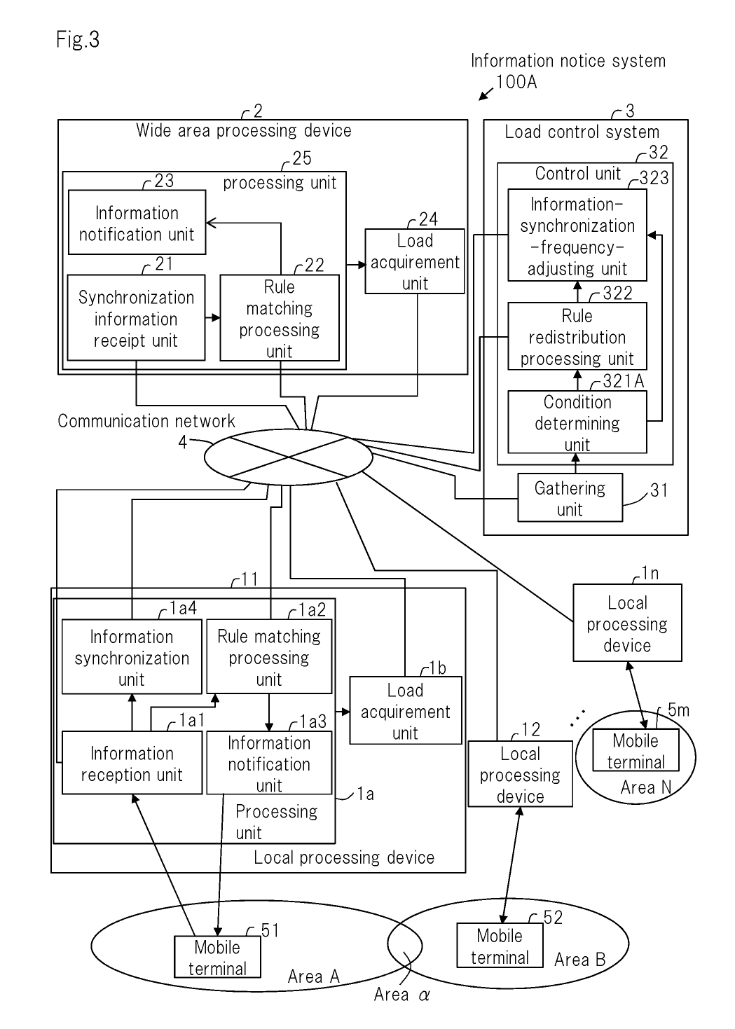

### BRIEF DESCRIPTION OF DRAWINGS

[FIG. 1] is a diagram showing information processing system 100 of a first exemplary embodiment according to the present invention.

[FIG. 2] is a flowchart for explaining the operation of load control system 3.

[FIG. 3] is a diagram showing information processing system 100A of a second exemplary embodiment according to the present invention.

### MODE THAT CARRIES OUT THE INVENTION

Exemplary embodiments according to the present invention will be described below with reference to the drawings.

### First Exemplary Embodiment

FIG. 1 is a diagram showing information processing system 100 of a first exemplary embodiment according to the present invention.

In FIG. 1, information processing system 100 includes local processing devices 11-1n (n is an integer that is equal to or greater than 1.), wide area processing device 2 and load control system 3. Local processing devices 11-1n, wide area processing device 2 and load control system 3 are each connected to communication network 4. A plurality of processing devices are made up of each of local processing devices 11-1n and wide area processing device 2.

Each of local processing devices 11-1n is one example of a predetermined processing device and one example of a first, second, third, fourth or fifth processing device. Each of local processing devices 11-1n is made up of one or more computers.

Areas A-N are assigned to local processing devices 11-1n respectively. Each of local processing devices 11-1n receives location information that indicates the location of a mobile terminal in the area that is assigned to the local processing device itself, and carries out the processing, which is assigned to the local processing device itself, by using the location information. Each of local processing devices 11-1n transmits the location information to wide area processing device 2.

The location information is one example of terminal relation information about a mobile terminal.

The mobile terminal is, for example, a communication device that is housed in a vehicle and that has a function of inter-vehicle communication, or is a mobile communication terminal.

In areas that are adjacent to each other, a part of the areas overlap. For example, in FIG. 1 area a overlaps in areas A and B. The local processing device that handles the location information of a mobile terminal in area a is set as local processing device 11 or 12 in advance. The setting can be changed. In the exemplary embodiment, it is assumed that local processing device 11 handles the location information of a mobile terminal in area α. In areas that are adjacent to each other, there may be not any areas that overlap.

Wide area processing device 2 is one example of a specific processing device or a second processing device.

Wide area processing device 2 receives the location information from each of local processing devices 11-1n, and carries out the processing, which is assigned to wide area processing device 2, by using the location information.

Each of local processing devices 11-1n includes processing unit la and load acquirement unit 1b. In FIG. 1, with regard to local processing devices that are different from local processing device 11, processing unit 1a and load acquirement unit 1b are omitted.

First, processing unit 1a and load acquirement unit 1b in local processing device 11 will be explained.

Processing unit 1a carries out a rule matching processing that is assigned to local processing device 11.

The rule matching processing means that data which arrives continuously (for example, location information) are handled based on some condition.

In the exemplary embodiment, a combination of a condition and processing (hereinbelow referred to as “execution processing”), which will be carried out when data satisfies the condition, is referred to as “rule”.

As one example of a rule, the rule: “communicating designated information when a vehicle enters the designated area” is cited. In this example, the part: “a vehicle enters the designated area” corresponds to “condition”. The part: “communicating designated information” corresponds to “execution processing”.

As another example of a rule, the rule: “communicating designated information when distances between a plurality of vehicles are equal to or greater than a predetermined distance” is cited. In this example, the part: “distances between a plurality of vehicles are equal to or greater than a predetermined distance” corresponds to “condition”. The part: “communicating designated information” corresponds to “execution processing”.

Processing unit 1a includes information reception unit 1a1, rule matching processing unit 1a2, information notification unit 1a3 and information synchronization unit 1a4.

Information reception unit 1a1 receives location information and terminal ID from mobile terminal 51 in area A. The terminal ID is, for example, an address of mobile terminal 51. Information reception unit 1a1 outputs the location information and terminal ID, which are received from mobile terminal 51, to rule matching processing unit 1a2 and information synchronization unit 1a4.

Information reception unit 1a1 transmits a combination of the location information and the terminal ID to other local processing devices according to an information presentation instruction that is received from load control system 3.

Information reception unit 1a1 receives combinations of location information and terminal ID, which are transmitted from other local processing devices to local processing device 11, and outputs these combinations to rule matching processing unit 1a2 and information synchronization unit 1a4.

Rule matching processing unit 1a2 stores rule information, which defines rule, for each rule. Each piece of rule information also defines processing time that is previously required with respect to the rule defined by the piece of the rule information.

Upon receipt of the location information and the terminal ID, rule matching processing unit 1a2 carries out, using the rule information and the location information, for example a rule matching processing that is relative to area A or a rule matching processing that is not relative to area A.

As rule matching processing that is relative to area A, for example, processing for executing, using the location information, the rule: “communicating advertisement information A1 when a vehicle enters area A” is cited.

As another rule matching processing that is relative to area A, for example, processing for executing, using the location information, the rule: “communicating advertisement information A2 when a vehicle enters area α” is cited.

As rule matching processing that is not relative to area A, for example, processing for executing, using the location information, the rule: “communicating traffic information A3 to mobile terminals at 6:00 PM” is cited.

Rule matching processing unit 1a2 carries out rule matching processing by stream processing, for example. Rule matching processing unit 1a2 may execute rule matching processing by processing that is different from stream processing (for example, processing using database).

Rule matching processing unit 1a2 transmits rule information, which defines a predetermined rule, to wide area processing device 2 and other local processing devices according to a rule division instruction that is received from load control system 3. The rule division instruction is one example of a transmission instruction.

For example, rule matching processing unit 1a2 transmits rule information, which defines a rule: “communicating advertisement information A2 when a vehicle enters area α”, to local processing device 12. This means that the local processing device, which is substantially assigned to area α, is changed from local processing device 11 to local processing device 12.

Rule matching processing unit 1a2 receives rule information that is transmitted from other local processing devices. Rule matching processing unit 1a2 stores the rule information that has been received, and executes the rule matching process about the rule, which is defined by the rule information, using the location information.

Rule matching processing unit 1a2 outputs to information notification unit 1a3 information (hereinbelow referred to as “notification information”), which must be notified according to a result of the rule matching processing, along with the terminal ID that is received together with the location information.

Upon receipt of the notification information and the terminal ID, information notification unit 1a3 transmits the notification information to mobile terminal 51 that is identified by the terminal ID.

Information synchronization unit 1a4 receives the location information and the terminal ID from information reception unit 1a1. Information synchronization unit 1a4 transmits combinations of the location information and the terminal ID that are received during the specific time period (for example, 10 seconds) all in one unit to wide area processing device 2. The specific time period is not limited to 10 seconds and can be modified as appropriate.

Information synchronization unit 1a4 may process the location information and the terminal ID, and may transmit the location information and the terminal ID, which are processed, to wide area processing device 2.

For example, information synchronization unit 1a4 may compress the location information and the terminal ID, may select the latest location information and the terminal ID for each mobile terminal (for each terminal ID) or may convert formats of the location information and the terminal ID.

Information synchronization unit 1a4 sets the specific time period in accordance with a communication probability instruction that is received from load control system 3.

Load acquirement unit 1b detects the magnitude of the load of processing unit 1a as a load of local processing device 11.

For example, load acquirement unit 1b may detect the utilization rate of processing unit 1a (for example, the utilization rate of a CPU in local processing device 11) as a load of local processing device 11, or may detect the length of queue of the location information in the waiting state to be processed in rule matching processing as a load of local processing device 11.

Load acquirement unit 1b generates load information that indicates the magnitude of the load of local processing device 11 periodically, and transmits the load information to load control system 3. The load information also functions as load degree information.

Since the functions of processing unit 1a and load acquirement unit 1b in each local processing device that is different from local processing device 11 follows the functions of processing unit 1a and load acquirement unit 1b in local processing device 11, explanations of those functions are omitted.

Wide area processing device 2 includes synchronization information receipt unit 21, rule matching processing unit 22 and information notification unit 23.

Synchronization information receipt unit 21 receives combinations between the location information and terminal ID from each of local processing devices 11-1n. Synchronization information receipt unit 21 outputs the combinations between the location information and terminal ID to rule matching processing unit 22.

Rule matching processing unit 22 stores rule information, which defines a rule, for each rule. Upon receipt of the location information and the terminal ID, rule matching processing unit 22 executes the rule matching processing using the location information and the terminal ID.

Rule matching processing unit 22 carries out, for example, rule matching processing that cannot be handled by local processing devices 11-1n (for example, rule matching processing that is executed by using the rule information that is provided from a local processing device, or rule matching processing that is previously assigned to rule matching process unit 22).

Rule matching processing unit 22 carries out the rule matching processing by stream processing, for example. Rule matching processing unit 22 may execute the rule matching processing by processing that is different from stream processing (for example, processing that uses database).

Rule matching processing unit 22 outputs notification information, which must be notified due to the result of the rule matching processing, along with the terminal ID that is received together with the location information, to information notification unit 23.

Upon receipt of the notification information and the terminal ID, information notification unit 23 transmits the notification information to a mobile terminal that is identified by the terminal ID. Information notification unit 23 may transmit the notification information to a mobile terminal, which is identified by the terminal ID, via a local processing device that has transmitted the terminal ID.

Load control system 3 is one example of a load control server, and made up of one or more computers.

Load control system 3 includes gathering unit 31 and control unit 32.

Gathering unit 31 is one example of receiving means. Gathering unit 31 receives load information from each of local processing devices 11-1n.

Control unit 32 is one example of control means. Control unit 32 controls load control system 3.

Control unit 32 determines whether or not a local processing device (hereinbelow referred to as “high load processing device”), in which the magnitude of the load indicated by the load information is equal to or greater than the level of a threshold, is present. A situation, in which the high load processing device is present, is one example of a specific situation. The level of the threshold is one example of a predetermined level, and is, for example, stored in control unit 32 (condition determining unit 321).

When a high load processing device is present, control unit 32 causes a processing device (hereinbelow referred to as “processing device that is to be distributed”), which is different from the high load processing device from among a plurality of processing devices, to execute a part of a processing that is assigned to the high load processing device (one or more rules from among rules that are possessed by the high load processing device).

Control unit 32 identifies, as a processing device that is to be distributed, a local processing device which is different from the high load processing device from among a plurality of local processing devices 11-1n or wide area processing device 2.

Control unit 32 includes condition determining unit 321, rule redistribution processing unit 322 and information-synchronization-frequency-adjusting unit 323.

Condition determining unit 321 determines, based on each piece of load information that are received by gathering unit 31, whether or not a high load processing device is present. Condition determining unit 321 identifies, based on each piece of load information that are received by gathering unit 31, the processing device that is to be distributed.

When condition determining unit 321 confirms the presence of a high load processing device and when condition determining unit 321 identifies wide area processing device 2 as a processing device that is to be distributed, rule redistribution processing unit 322 transmits to the high load processing device a rule division instruction to transmit to the processing device that is to be distributed rule information (hereinbelow referred to as “redistribution rule information”) related to one or more rules from among a plurality of rules that are possessed by the high load processing device.

In the exemplary embodiment, rule redistribution processing unit 322 confirms the rule information of the high load processing device in order to identify the redistribution rule information.

When condition determining unit 321 identifies any one of the local processing devices as a processing device that is to be distributed, rule redistribution processing unit 322 transmits to the high load processing device a rule division instruction to transmit the redistribution rule information to the processing device that is to be distributed (any one of the local processing devices) and an information providing instruction to transmit to the processing device that is to be distributed the combination of the location information and the terminal ID that is received by the high load processing device.

When condition determining unit 321 confirms the presence of a high load processing device and when condition determining unit 321 identifies wide area processing device 2 as a processing device that is to be distributed, information-synchronization-frequency-adjusting unit 323 transmits to the high load processing device a communication probability instruction instructing that a time, which is shorter than a processing time for rule of redistribution that is specified by the rule division instruction, is to be used as a specific time period.

The operation is next described.

FIG. 2 is a flowchart explaining an operation of load control system 3

Gathering unit 31 receives load information from each of local processing devices 11-1n (step S201). Subsequently, gathering unit 31 outputs the load information of each of local processing devices 11-1n to condition determining unit 321.

Upon receipt of the load information of each of local processing devices 11-1n, condition determining unit 321 refers to each load information, and then determines whether or not a local processing device (a high load processing device), in which the magnitude of the load is equal to or greater than the level of the threshold, is present (step S202).

When the high load processing device is present at step S202, condition determining unit 321 refers to the load information of local processing devices that are different from the high load processing device, and then determines whether or not local processing devices (hereinbelow referred to as “low load processing devices”), in which the magnitude of the load is smaller than the level of the threshold, are present (step S203). The low load processing device is one example of a fourth processing device.

When one or more low load processing devices are present at step S203, condition determining unit 321 identifies any one of the low load processing devices as the processing device that is to be distributed (step S204).

In the exemplary embodiment, condition determining unit 321 identifies, as the processing device that is to be distributed, a close low load processing device (a fifth processing device), whose assigned area is the closest to the area that is assigned to the high load processing device, from among the low load processing devices.

When identifying the high load processing device and the close low load processing device (processing device that is to be distributed), condition determining unit 321 outputs first specific information, which indicates the high load processing device and the close low load processing device, to rule redistribution processing unit 322.

Upon receipt of the first specific information, rule redistribution processing unit 322 confirms the rule information of the high load processing device, and then identifies redistribution rule information that is to be transferred from the high load processing device to the close low load processing device (processing device that is to be distributed).

For example, when the degree of priority about distribution is added to the rule information of the high load processing device in advance, rule redistribution processing unit 322 identifies rule information, which has top n (n is an integer that is one or more) of the degree of priority, as the redistribution rule information.

Rule redistribution processing unit 322 may identify the redistribution rule information from among the rule information of the high load processing device at random.

When the rule information of the high load processing device includes adjacency rule information that defines a rule about an area (for example, area α in FIG.1) that overlaps an area in which a close low load processing device is present, rule redistribution processing unit 322 identifies the adjacency rule information as the redistribution rule information.

Subsequently, rule redistribution processing unit 322 transmit to the high load processing device a rule division instruction to transmit the redistribution rule information to the close low load processing device and an information providing instruction to transmit to the close low load processing device the combination of the location information and the terminal ID that is received by the high load processing device (step S205).

Upon receipt of the rule division instruction, rule matching processing unit 1a2 in the high load processing device transmits the redistribution rule information, which is indicated by the rule division instruction, to the close low load processing device. After receiving the information providing instruction, information reception unit 1a1 transmits the combination of the location information and the terminal ID to the close low load processing device.

In the close low load processing device, rule matching processing unit 1a2 executes the rule, which is defined by the redistribution rule information that is transmitted from the high load processing device, using the location information that is transmitted from the high load processing device.

When one or more of the low load processing devices are not present at step S203, condition determining unit 321 identifies wide area processing device 2 as the processing device that is to be distributed (step S206).

When identifying the high load processing device and wide area processing device 2 (processing device that is to be distributed), condition determining unit 321 outputs second specific information, which indicates high load processing device and wide area processing device 2, to rule redistribution processing unit 322 and information-synchronization-frequency-adjusting unit 323.

Upon receipt of the second specific information, rule redistribution processing unit 322 confirms the rule information of the high load processing device, and then identifies redistribution rule information that is to be transferred from the high load processing device to wide area processing device 2 (step S207).

In the exemplary embodiment, rule redistribution processing unit 322 preferentially identifies pieces of the rule information, which define each rule whose desired processing time is long, from among a plurality of pieces of the rule information of the high load processing device, as the redistribution rule information. The number of pieces of the redistribution rule information can be modified as appropriate.

When a high load processing device has rule R1 whose desired processing time is equal to or less than 10 s (seconds), rule R2 whose desired processing time is equal to or less than 100 ms and rule R3 whose desired processing time is equal to or less than 10 ms, rule redistribution processing unit 322 identifies rule information of rule R1 whose desired processing time is the longest (response performance condition is low) in rules R1-R3 as the redistribution rule information.

Subsequently, rule redistribution processing unit 322 transmits to the high load processing device a rule division instruction to transmit the redistribution rule information to wide area processing device 2 (step S208).

Upon receipt of the rule division instruction, rule matching processing unit 1a2 in the high load processing device transmits the redistribution rule information, which is indicated by the rule division instruction, to wide area processing device 2.

Subsequently, rule redistribution processing unit 322 outputs processing time information, which indicate the shortest time from among the processing times that are requested by the redistribution rule information, to information-synchronization-frequency-adjusting unit 323.

When receiving the second specific information from condition determining unit 321 and when receiving the processing time information from rule redistribution processing unit 322, information-synchronization-frequency-adjusting unit 323 transmits to the high load processing device a communication probability instruction instructing that a time that is shorter than a processing time, which is indicated by the processing time information (step S209), is be used as the specific time.

For example, when the rule information of rule R1 is identified as the redistribution rule information and when the processing time information indicates 10 s, information-synchronization-frequency-adjusting unit 323 transmits communication probability information, which instructs that 5 s, which is shorter than 10 s, be used as the specific time, to the high load processing device.

Upon receipt of the communication probability instruction, information synchronization unit 1a4 in the high load processing device sets as the specific time period (time interval at which the high load processing device transmits to wide area processing device 2 the combination of the location information and the terminal ID that are received from a mobile terminal) a time that is shorter than the time that is indicated by the communication probability instruction.

Therefore, wide area processing device 2 can handle the rule, which is defined by the redistribution rule information provided from the high load processing device, within the processing time that the rule requires.

When the high load processing device is not present at step S202, the processing in FIG. 2 is ended.

Load control system 3 repeats the processing in FIG. 2 at regular intervals.

Next, effects of the exemplary embodiment will be described.

According to the exemplary embodiment, gathering unit 31 receives the load information which indicates the magnitude of the load of the first processing device, which is one processing device from among plurality of processing devices. In a specific situation in which the magnitude of the load is equal to or greater than the level of the threshold, control unit 32 causes the second processing device, which is different from the first processing device from among the plural processing devices, to carry out a part of the processing that is assigned to the first processing device (the high load processing device).

Therefore, it is possible to inhibit the concentration of the load in the first processing device.

The effect described above is also exhibited in load control system 3 that is made up of gathering unit 31 and control unit 32.

In the exemplary embodiment, the first processing device is any one from among a plurality of local processing devices 11-1n, and the second processing device is wide area processing device 2, and control unit 32 causes wide area processing device 2 to execute a part of processing that is performed by the first processing device by transmitting to the first processing device the rule division instruction to transmit to wide area processing device 2 redistribution rule information, which defines the part of the processing that is performed by the first processing device, in the specific situation.

Therefore, control unit 32 can cause wide area processing device 2 to execute the part of the processing that is performed by the first processing device by transmitting the rule division instruction.

Control unit 32 (for example, rule redistribution processing unit 322) may acquire redistribution rule information from the first processing device, and may transmit the redistribution rule information to wide area processing device 2.

In the exemplary embodiment, the first processing device is a local processing device that transmits the location information, which is received during a specific time period, all in one unit to wide area processing device 2, and control unit 32 adjusts the specific time period in accordance with the processing time that is previously desired with regard to the part of the processing that is performed by the first processing device.

Therefore, it is possible to provide the location information, which is necessary to carry out the processing that has been transferred to wide area processing device 2, to wide area processing device 2 at time interval that is shorter than the processing time that the processing previously requires. Accordingly, it is possible to handle the processing, which has been transferred to wide area processing device 2, within the processing time that the processing previously requires.

In the exemplary embodiment, when the specific situation no longer exists after causing wide area processing device 2 to execute the part of the processing that is performed by the first processing device, control unit 32 (rule redistribution processing unit 322) may return the part of the processing which has been transferred to wide area processing device 2 to the first processing device.

For example, when condition determining unit 321 determines that the specific situation no longer exists, rule redistribution processing unit 322 returns the part of the processing which has been transferred to wide area processing device 2 to the first processing device by transmitting to wide area processing device 2 a rule return instruction to transmit to the first processing device the redistribution rule information that was identified in the specific situation.

In this case, it is possible to inhibit the concentration of the load in wide area processing device 2.

In the exemplary embodiment, based on the load information, control unit 32 identifies a low load processing device, as a second processing device, in which the magnitude of the load is less than the level of the threshold, from among local processing devices that are different from the first processing device.

Therefore, it is possible to transfer a part of a load of a processing device whose load is high to a processing device whose load is low, and it is possible to give a load to a processing device that can afford to execute a load without concentrating a load in one processing device.

In the exemplary embodiment, control unit 32 identifies a close low load processing device, as a second processing device, whose assigned area is the closest to the area that is assigned to the first processing device (high load processing device) from among low load processing devices.

Therefore, it is possible to shorten a communication range with respect to information that is transmitted from the first processing device to the second processing device, the information range being necessary to cause the second processing device to execute the part that is performed by the processing of the first processing device.

In the exemplary embodiment, in the specific situation, control unit 32 causes the low load processing device to execute the part of the processing by transmitting to the first processing device a rule division instruction to transmit to the low load processing device the distribution rule information that defines the part of the processing of the first processing device (high load processing device) and by providing the low load processing device with the location information that is necessary to control the first processing device in order to carry out the part of the processing.

Control unit 32 (for example, rule redistribution process unit 322) may gather the rule division information from the first processing device, and then may transmit the rule division instruction to the low load processing device.

In the exemplary embodiment, control unit 32 transmits the information providing instruction to the first processing device in order to provide the low load processing device with the location information that is necessary to carry out a part of the processing.

However, control unit 32 may causes the low load processing device to execute a part of the processing by controlling a mobile terminal in an area that is assigned to the first processing device in order to transfer the location information, which is necessary to carry out a part of the processing, from the mobile terminal to the low load processing device.

For example, control unit 32 (rule redistribution processing unit 322) may provide the location information, which is necessary to carry out a part of the processing, to the low load processing device by acquiring the terminal ID, which is received by the first processing device, from the first processing device, and by transmitting to the mobile terminal, which is identified by the terminal ID, a destination change instruction to change destination of the location information into the first processing device and the low load processing device.

When local processing device 11 is a high load processing device and when local processing device 12 is a low load processing device, for example, control unit 32 (rule redistribution processing unit 322) may causes local processing device 12 to execute a part of the processing of local processing device 11 by changing a processing device that executes rule matching processing with respect to the location information of a mobile terminal in area a from local processing device 11 to local processing device 12.

In this case, the rule information, which defines rule matching processing with respect to the location information of a mobile terminal in area α, is provided to local processing device 12. In this case, control unit 32 (rule redistribution processing unit 322) may provide local processing device 12 with the location information, which is necessary to carry out the rule matching processing with respect to the location information of a mobile terminal in area α, by acquiring the location information and the terminal ID, which are received by local processing device 11, from local processing device 11, and by transmitting to the mobile terminal, which has the location information that indicates area α, a destination change instruction to change the destination of the location information into local processing device 12.

In the exemplary embodiment, control unit 32 identifies the local processing device, which is different from the first processing device, or wide area processing device 2 as a second processing device.

Control unit 32 may identify both the local processing device which is different from the first processing device and wide area processing device 2 as second processing devices. In this case, control unit 32 distributes a part of the processing that is performed by the first processing device to the local processing device which is different from the first processing device and to wide area processing device 2.

In the exemplary embodiment, in the specific situation, control unit 32 determines whether or not the magnitude of the load of the local processing device (hereinbelow referred to as “subject local processing device”) which is different from the first processing device is lower than the level of the threshold in accordance with the load information. When the magnitude of the load of the subject local processing device is lower than the level of the threshold, control unit 32 identifies the subject local processing device as the second processing device. When the magnitude of the load of the subject local processing device is equal to or greater than the level of the threshold, control unit 32 identifies wide area processing device 2 as the second processing device.

Therefore, the local processing device is selected as the second processing device with priority to wide area processing device 2. Consequently, control unit 32 can reduce frequency of output of communication probability instructions.

When the magnitude of the load of the subject local processing device is lower than the level of the threshold, control unit 32 may identify both the subject local processing device and wide area processing device 2 as the second devices. In this case, control unit 32 distributes the part of the processing of the first processing device to the subject local processing device and to wide area processing device 2.

### Second Exemplary Embodiment

In the first exemplary embodiment, if the low load processing device is any one from among local processing devices which are different from the first processing device, the local processing device (local processing device) is selected as the second processing device with priority to wide area processing device 2.

In the second exemplary embodiment, even if the low load processing device is any one from among local processing devices which are different from the first processing device, wide area processing device 2 is selected as the second processing device with priority given to the local processing devices.

FIG. 3 is a diagram showing information processing system 100A of the second exemplary embodiment according to the present invention. In FIG. 3, the same reference signs are assigned to configurational elements that are identical to those shown in FIG. 1.

The second exemplary embodiment is different from the first exemplary embodiment in that, in the second exemplary embodiment, wide area processing device 2 also includes load acquirement unit 24 and condition determining unit 321A is used instead of condition determining unit 321.

Regarding the second exemplary embodiment, points that are different from the first exemplary embodiment will be mainly explained.

Load acquirement unit 24 detects the magnitude of the load of processing unit 25, which includes synchronization information receipt unit 21, rule matching processing unit 22 and information notification unit 23, as a load of wide area processing device 2.

For example, load acquirement unit 24 may detect the utilization rate of processing unit 25 (for example, the utilization rate of CPU in wide area processing device 2) as the load of wide area processing device 2, or may detect the length of the location information that is in state in which it is waiting to be processed, according to rule matching processing, as a load of wide area processing device 2.

Load acquirement unit 24 generates specific load information that indicates the magnitude of the load of wide area processing device 2 periodically, and transmits the specific load information to load control system 3.

Condition determining unit 321A has functions that are identical to the functions of condition determining unit 321 in FIG. 1. However, a way to identify the second processing device is different.

In the specific situation, when the magnitude of the load of wide area processing device 2 that is indicated by the specific load information is lower than a prescribed level, condition determining unit 321A identifies wide area processing device 2 as the second processing device. The prescribed level is, for example, stored in condition determining unit 321A.

In the specific situation, when the magnitude of the load of wide area processing device 2 is equal to or greater than the prescribed level and when the magnitude of the load of the local processing device that is different from the first processing device is lower than the prescribed level, condition determining unit 321A identifies the local processing device, in which the magnitude of the load is lower than the prescribed level, as the second processing device.

In the specific situation, when the magnitude of the load of wide area processing device 2 is equal to or greater than the prescribed level and when the magnitude of the load of the local processing device that is different from the first processing device is equal to or greater than the prescribed level, condition determining unit 321A does not identify the second processing device.

According to the exemplary embodiment, in the specific situation, when the magnitude of the load of wide area processing device 2 that is indicated by the specific load information is lower than a prescribed level, condition determining unit 321A identifies wide area processing device 2 as the second processing device.

Therefore, it is possible to choose wide area processing device 2 as the second processing device with priority given to the local processing devices.

When the local processing device is identified as the second processing device, a processing for providing the location information that is received by the first processing device to the second processing device (local processing device) takes place. And when the local processing device is identified as the second processing device, the local processing device that is assigned to area α in FIG. 3 may be changed.

Since wide area processing device 2 is selected as the second processing device with priority given to the local processing devices in the exemplary embodiment, it is possible to inhibit an increase of a processing for providing the location information, which is received by the first processing device, to the second processing device (local processing device), and it is possible to reduce changes for assignment of an area to the local processing device.

In each exemplary embodiment indicated above, a situation, in which a high load processing device in which the magnitude of the load that is indicated by the load information is equal to or greater than the level of the threshold is present, is used as the specific situation. However, for example, a situation, in which the magnitude of the load that is indicated by the load information approaches the level of the threshold (a situation in which the high load processing device will occur), may be used as the specific situation.

In each exemplary embodiment indicated above, the location information of the mobile terminal is used as the terminal relation information. However, the terminal relation information is not limited to the location information and can be modified as appropriate. For example, attribute information (gender or age and so on) of a user of the mobile terminal or information (for example, a detection result of an acceleration sensor or an image that is generated by a camera) from a sensor that is connected to the mobile terminal may be used as the terminal relation information. Various rules that correspond to kinds of the terminal relation information may be set to each local processing device and wide area processing device 2.

Load control system 3 may be included in any one of the processing devices, or may be included in each of two or more processing devices.

According to each exemplary embodiment indicated above, the following effects are generated.

It is possible to realize an information notification service using limited resources since load distribution of the processing devices is realized.

For example, it is possible to cover a change of the number of the mobile terminals (for example, vehicles) according to a time zone or a load change that is generated by a sudden movement of the mobile terminal (for example, vehicles) due to a disaster and so on by using a surplus resources that are in any one of the processing devices.

By redistributing rules in response to the order of priority or a response performance condition (process time), it is possible to realize an information notification service using limited resources while maintaining performance that is required by a rule.

By lowering the transmission frequency in information synchronization unit 1a4 to a range in which the response performance condition of a rule is assured, it is possible to reduce the amount of utilization of a communication band between the local processing device and wide area processing device 2.

It is possible to reduce the amount of utilization of a communication band that is used when information synchronization unit 1a4 compresses information (data).

Information synchronization unit 1a4 transmits the location information to wide area processing device 2 without synchronizing the timing at which information reception unit 1a1 receives the location information. Therefore, it is possible to reduce a frequency (the amount of processing) of the rule matching processing that is executed in wide area processing device 2 in accordance with lengthening the transmission intervals of the location information, and it is possible to reduce resources that are used in wide area processing device 2.

In each exemplary embodiment, load control system 3 may be implemented by a computer. In this case, the computer reads and executes a program that is recorded on a recording medium such as a CD-ROM (Compact Disk Read Only Memory) that can be read in a computer and then functions as gathering unit 31, condition determining unit 321 or 321A, rule redistribution processing unit 322 and information-synchronization-frequency-adjusting unit 323. The recording medium is not limited to a CD-ROM and can be modified as appropriate.

In each of the above-described exemplary embodiments, the configurations shown in the drawings are merely examples and the present invention is not limited to these configurations.

Although the invention of the present application has been described with reference to the exemplary embodiments, the invention of the present application is not limited to the above-described exemplary embodiments. The configuration and details of the invention of the present application are open to various modifications within the scope of the invention of the present application that will be clear to one of ordinary skill in the art. This application claims the benefits of priority based on Japanese Patent Application No. 2012-173799 for which application was submitted on August 6, 2012 and incorporates by citation all of the disclosures of that application.

### DESCRIPTION OF REFERENCE NUMERALS

100, 100A information notice system

11-1n local processing device

1a processing unit

1a1 information reception unit

1a2 rule matching processing unit

1a3 information notification unit

1a4 information synchronization unit

1b load acquirement unit

2 wide area processing device

21 synchronization information receipt unit

22 rule matching processing unit

23 information notification unit

24 load acquirement unit

3 load control system

31 gathering unit

32 control unit

321,321A condition determining unit

322 rule redistribution processing unit

323 information-synchronization-frequency-adjusting unit

4 communication network

51-5m mobile terminal

1. A load control system comprising:
a receiving unit that receives load information that indicates a magnitude of a load of a first processing device, which is one processing device from among processing devices that receive terminal relation information about a mobile terminal and that carry out a processing, which is assigned to the processing device itself, by using the terminal relation information; and
in a specific situation in which the magnitude of the load is equal to or greater than a predetermined level or is approaching the predetermined level, a control unit that causes a second processing device, which is different from the first processing device from among the processing devices, to carry out a part of the processing that is assigned to the first processing device.

2. The load control system according to claim 1, wherein:
the first processing device is a processing device that receives terminal relation information of the mobile terminal in an area that is assigned to the processing device itself in order to transmit the terminal relation information to the second processing device;
the second processing device is a processing device that receives the terminal relation information via the first processing device; and
the control unit causes the second processing device to carry out the part of the processing by transmitting to the first processing device a transmission instruction to transmit content of processing information that defines the part of the processing to the second processing device.

3. The load control system according to claim 2, wherein:
the first processing device is a processing device that transmits the terminal relation information, which is received during a specific time period, all in one unit to the second processing device; and
the control unit adjusts the specific time period in accordance with a processing time that was previously required by the part of the processing.

4. The load control system according to claim 2, wherein:
when the specific situation no longer exists after causing the second processing device to execute the part of the processing, the control unit returns the part of the processing to the first processing device.

5. The load control system according to claim 1, wherein:
the receiving unit further receives load degree information that indicates a magnitude of a load of each third processing device that is different from the first processing device from among the processing devices, and
the control unit identifies a fourth processing device, in which a magnitude of a load is less than the predetermined level, from among third processing devices as the second processing device.

6. The load control system according to claim 5, wherein:
each of the first and third processing device is a device that receives the terminal relation information of the mobile terminal in an area that is assigned to the device itself, and
the control unit identifies a fifth processing device, whose assigned area is the closest to an area that is assigned to the first processing device from among the fourth processing devices, as the second processing device.

7. The load control system according to claim 5, wherein:
the control unit causes the second processing device to execute the part of the processing by transmitting to the first processing device a transmission instruction to transmit to the second processing device content of processing information that defines the part of the processing and by providing the second processing device with the terminal relation information that is necessary to control the first processing device or the mobile terminal in an area that is assigned to the first processing device in order to carry out the part of the processing.

8. The load control system according to claim 1, wherein:
the processing devices are made up of each of two or more predetermined processing devices, which receives the terminal relation information of the mobile terminal in an area that is assigned to the predetermined processing device, and are made up of a specific processing device that receives the terminal relation information via the predetermined processing device,
the first processing device is any one of the two or more predetermined processing devices, and
the control unit identifies a third processing device, which is different from the first processing device from among the two or more predetermined processing devices and/or the specific processing device as the second processing device.

9. The load control system according to claim 8, wherein:
the receiving unit further receives specific load information that indicates a magnitude of a load of the specific processing device, and
when the magnitude of the load of the specific processing device that is indicated by the specific load information is lower than a prescribed level in the specific situation, the control unit identifies the specific processing device as the second processing device.

10. The load control system according to claim 8, wherein:
the receiving unit further receives load degree information that indicates a magnitude of a load of the third processing device, and
in the specific situation, the control unit determines, based on the load degree information, whether or not the magnitude of the load of the third processing device is lower than the predetermined level, and the control unit identifies the third processing device or both the third processing device and the specific processing device as the second processing devices when the magnitude of the load is lower than the predetermined level, and the control unit identifies the specific processing device as the second processing device when the magnitude of the load is equal to or greater than the predetermined level.

11. A load control server comprising:
a receiving unit that receives load information that indicates a magnitude of a load of a first processing device, which is one processing device from among processing devices that receive terminal relation information about a mobile terminal and that carry out a processing, which is assigned to the processing device itself, by using the terminal relation information; and
in a specific situation in which the magnitude of the load is equal to or greater than a predetermined level or is approaching the predetermined level, a control unit that causes a second processing device, which is different from the first processing device from among the processing devices, to carry out a part of the processing that is assigned to the first processing device.

12. An information processing system comprising:
the load control system according to claim 1 or the load control server according to claim 11, and
the processing devices.

13. A load control method that is carried out by a load control system comprising:
receiving load information that indicates a magnitude of a load of a first processing device, which is one processing device from among processing devices that receive terminal relation information about a mobile terminal and that carry out a processing, which is assigned to the processing device itself, by using the terminal relation information; and
in a specific situation in which the magnitude of the load is equal to or greater than a predetermined level or is approaching the predetermined level, causing a second processing device, which is different from the first processing device from among the processing devices, to carry out a part of the processing that is assigned to the first processing device.

14. A computer readable recording medium that records a program causing a computer to execute procedures comprising:
receiving load information that indicates a magnitude of a load of a first processing device, which is one processing device from among processing devices that receive terminal relation information about a mobile terminal and that carry out a processing, which is assigned to the processing device itself, by using the terminal relation information; and
in a specific situation in which the magnitude of the load is equal to or greater than a predetermined level or is approaching the predetermined level, causing a second processing device, which is different from the first processing device from among the processing devices, to carry out a part of the processing that is assigned to the first processing device.
